(19) United States
(12) Patent Application Publication
(10) Pub. No.: US 2002/0092847 A1
(43) Pub. Date: Jul. 18, 2002

(54) Method and device for heating a roll

(75) Inventors: Pekka Kiiski, Tampere (FI); Pekka Hoyssa, Vesilahti (FI); Risto Saynavajarvi, Soderkulla (FI)

Correspondence Address: STEINBERG & RASKIN, P.C., 1140 AVENUE OF THE AMERICAS, 15th FLOOR, NEW YORK, NY, 10036-5803, US

(73) Assignee: METSO PAPER AUTOMATION OY

(21) Appl. No.: 10/043,687

(22) Filed: Jan. 11, 2002

(30) Foreign Application Priority Data
Jan. 15, 2001 (FI) 20010086

(51) Int. Cl. H05B 6/14

(52) U.S. Cl. 219/619; 219/676

(57) ABSTRACT

In the method for heating a roll in a paper or paperboard machine or finishing machine for paper or paperboard, several adjacent induction coils (2) are used which are located at different points in the axial direction of the roll, and said induction coils are made to move back and forth in the axial direction of the roll with respect to the roll (3) to be heated. The movement is utilized to even out such an irregular power distribution and correspondingly uneven heating response in the axial direction of the roll which result from the structure and/or mutual location of individual coils, and it can be used e.g. for profiled induction heating of a calender roll.

### FIELD OF THE INVENTION

The present invention relates to a method for heating a roll in a paper or paperboard machine or finishing machine for paper or paperboard, in which several adjacent induction coils are used which are located at different points in the axial direction of the roll. The present invention also relates to a device for heating a roll in a paper or paperboard machine or finishing machine for paper or paperboard, the device including induction coils in a supporting structure at different locations in the axial direction of the roll.

### BACKGROUND OF THE INVENTION

In paper or paperboard machines or finishing machines for paper or paperboard, rotating rolls are used for treating the paper web. Such rolls are used especially in calenders, wherein linear load and/or heat is/are exerted on the web passing by the roll to treat the web in the desired manner. The calender may be placed either in the production line of paper, wherein it treats the web coming from the drying section of the paper machine, or it may be located in a separate paper finishing machine, to which the processed paper web is unwound from reels. Other rolls that treat the web by means of heat and/or pressure include rolls of the press section and drying cylinders of the drying section.

The calender roll is arranged rotatable in the frame of the calender in such a manner that it forms a so-called calender nip with the moving surface of a counter element, wherein the paper web to be processed is guided through this nip. The counter element on the other side of the nip may be another rotating calender roll, but also a continuous belt passed via a roll or a stationary supporting surface. In its simplest form the calender may be formed of one nip, but may also consist of two or more nips, which each can be formed between a calender roll and an opposite moving element. To produce successive nips in the travel direction of the web, the pairs of a calender roll and a counter element may be separate units in the frame of the calender, or a so-called roll stack may be formed of the calender rolls, wherein the web travels along a winding path via the nips formed between the rolls.

The calendering nip may be formed between two hard surfaces, for example between two smooth-faced metal rolls, or between a hard surface and a soft surface, wherein the latter is typically attained with a soft cover in a metal-faced roll or by means of an elastic belt passed over the roll or a stationary shoe element.

It is common in all the aforementioned solutions to heat a metal-faced roll, and there are many alternatives for heating the roll, such as a heating medium fed inside the roll, radiation heating by means of heating elements outside or inside the roll, or induction heating by means of a magnetic field with induction coils arranged inside or outside the roll.

Examples of induction heating are disclosed for example in Finnish patent 71375 and in the corresponding U.S. Pat. No. 4,614,565, Finnish publication 74825 and in the corresponding U.S. Pat. No. 4,384,514 as well as in the European patent 196264. These publications disclose induction heating by means of electromagnetic coils i.e. induction coils arranged outside the shell of the roll. It is also possible to conduct the heating by controlling each roll separately, wherein temperature profiling can be attained, by means of which it is also possible to affect the nip profile through thermal expansion of metal.

An induction heater that is arranged inside a rotating roll and exerts a magnetic field on the shell of the roll is, in turn, disclosed in U.S. Pat. Nos. 4,425,489, 5,074,019 and 5,895,598. The electromagnetic coils located in the induction heater may be independently controllable to perform the induction heating in a profiled manner.

Furthermore, Finnish patent application 980557 discloses the possibility of placing zonewise controlled induction coils inside a polymer-coated calender roll.

Thus, electromagnetic coils, i.e. induction coils are commonly used for heating of the outer surface of rotating rolls in a finishing machine for paper up to a fixed temperature by producing eddy currents in the shell of the roll by means of induction, said eddy currents heating the shell of the roll in such a manner that the outer surface of the shell that is in contact with the web, reaches a predetermined temperature.

Thus, it is well-known to use induction heaters for heating calender rolls in such a manner that as a result of locally adjusted thermal expansion of the shell of the roll, the desired nip profile and thereby the adjustment of the thickness profile of paper passed through the nip is attained. Profiling induction heaters, which are disclosed for example in the aforementioned publications, are also well-known. Conventional induction heaters apply curved induction coils designed to comply with the diameter of the roll and having an elliptical shape when seen in the direction of the radius of the roll. The coils are placed diagonally with respect to the travel direction of the web. By means of this arrangement it has become possible to distribute the effect of the induction coils evenly in the axial direction of the roll to be heated. In this case the coils have to be dimensioned separately for each roll, which increases the work required in the manufacture of the induction heaters and raises the manufacturing costs, because each induction coil dimensioned in accordance with a given roll must have a mould of its own.

### OBJECTS AND SUMMARY OF THE INVENTION

It is an aim of the invention to introduce a method by means of which the aforementioned drawbacks can be eliminated in such a manner that it is possible to use induction coils with low manufacturing costs. It is also an aim of the invention to introduce a method by means of which it is possible to of the invention to introduce a method by means of which it is possible to generally improve the accuracy and regularity of induction heating.

In the method induction coils that are placed adjacently at suitable intervals across the width of the roll are made to move back and forth in the axial direction of the roll, wherein for example uneven power distribution due to the structure and/or mutual location of individual coils and the corresponding uneven heating response in the axial direction of the roll do not cause any inconvenience. The amplitude of the reciprocating movement can be arranged such that the local minimum and maximum points of the power distribution are not located at the same point all the time, but they change places in a pace determined by the frequency of the motion, and consequently irregularities even out.

It is, for example, possible to change the power of the coils according to the phase of the reciprocal motion they are in, wherein it is possible to reduce local minimum and maximum points even better across the width of the roll. The power adjustment depending on the momentary location of the coils also provides possibilities for profiling.

Another aim of the invention is to introduce a device by means of which it is possible to implement precise heating of the rolls with an induction heater.

Individual induction coils are mounted in a supporting structure located at suitable intervals in the cross-machine direction (in the axial direction of the roll), and this supporting structure is connected to an actuator, which makes the supporting structure move back and forth in the cross-machine direction. The coils may be located in one row in the supporting structure, or for example in two rows, wherein the coils in the second row are disposed between the coils in the first row, i.e. the induction coils are arranged in a staggered relationship on the supporting structure.

### BRIEF DESCRIPTION OF THE DRAWINGS

In the following, the invention will be described in more detail with reference to the appended drawings, in which

FIG. 1 shows a front-view of the device according to the invention,

FIG. 2 shows a side-view of the device placed in connection with a heated roll,

FIG. 3 shows the heating response of an individual induction coil as a function of the location, and

FIG. 4 shows the implementation of the movement of the device and power adjustment in accordance with the location.

### DETAILED DESCRIPTION OF THE INVENTION

FIG. 1 shows the device in a front-view i.e. seen in the direction of the radius of the heated roll. The device comprises an elongate longitudinal supporting structure 1 extending in the cross direction of the web, “an induction heating beam”, on which induction coils 2 of equal size are placed at fixed intervals. The induction coils are circular in the cross-section taken in the axial plane. To even out the points of discontinuity resulting from the distances between the coils, the coils 2 are staggered in such a manner that they are located in two parallel rows so that the coils in the second row are positioned between the coils in the first row. The induction coils 2 are placed so that their areas of influence overlap each other partly. Letter Z indicates the zone of a single coil 2. In this context, the zone Z is the area in the axial direction of the roll in which the heating response of the coil is at least as great or greater than the heating response of the adjacent coil, when all coils function with the same power in unprofiled heating. When the coils are located adjacently at different locations in the axial direction of the roll, the zone is the area remaining between the intersection points of the coil-specific curves indicating the heating response as a function of the axial location. The width of the zone and the gap between the coils is selected to be such that the heating response is as even as possible in unprofiled heating in the axial direction of the roll. The induction coils 2 can thus be distributed in such a manner that areas where points of discontinuity or “heating power pits” would exist do not remain between the coils for example due to the intermeshed location.

The iron core of the above-described iron coils 2 is standardized, and coils are also otherwise identical with each other. The manufacturing costs of such coils are small, because they can be manufactured in large batches for rolls of different types and sizes. It is typical for the coils that an insulated conductor provided with cooling is wrapped as a winding around the core. A Litz cable known as such, which is made of copper, can be mentioned as an example of the conductor structure itself. The core and the winding around the same can have a circular or otherwise regular shape in the plane of the winding. The shape of the coil in said plane is thus symmetrical with respect to at least one straight line. When the coils are placed towards the roll surface in such a manner that these straight lines are parallel to the periphery of the roll, the heating response in the axial direction is symmetrical with respect to the aforementioned straight line, but there may also be local minimum and maximum points that lie symmetrically with respect to said straight line. The scope of the invention, however, covers the idea according to which the straight lines of symmetry do not coincide with the direction of the periphery of the roll (the direction of rotation).

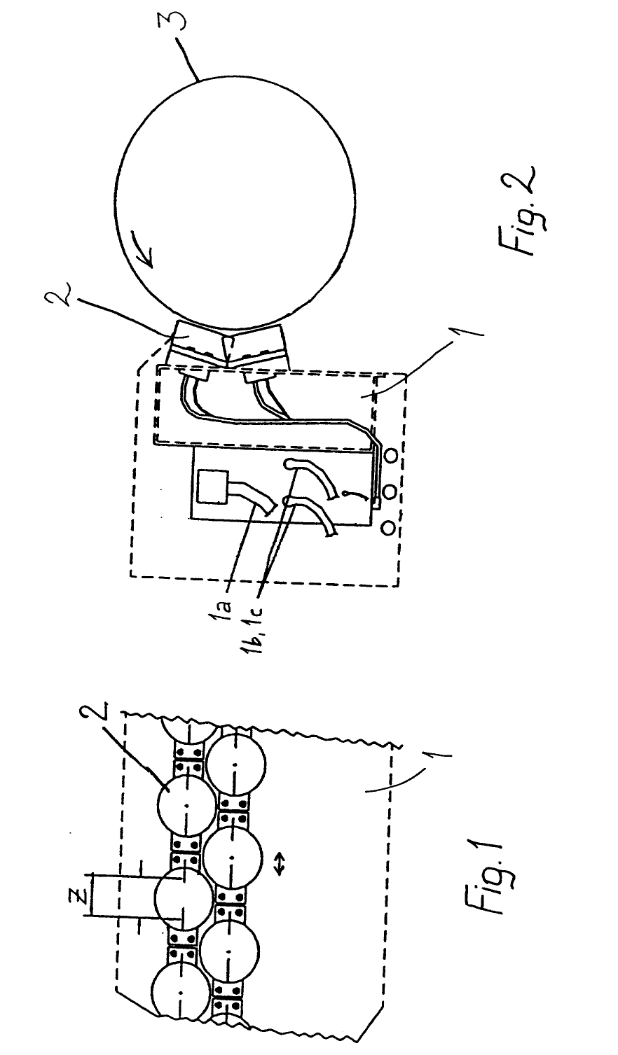

FIG. 2 shows the device according to FIG. 1 in a side view, positioned in connection with a rotating roll 3 in a paper or paperboard machine or a finishing machine for paper or paperboard. The supporting structure 1 to be moved in the axial direction is marked with broken lines, and it may also contain switch cabinets for electric couplings of the induction coils. Because the frequency of the reciprocating movement does not have to be high, it is possible to move even a larger structure in a controlled manner with normal actuators. As can be seen in FIG. 2, the induction coils 2 are positioned close to the surface of the heated roll 3 in such a manner that only a narrow air gap remains therebetween. The induction coils 2 are directed towards the surface of the roll 3 so that their central axis coincides with the radius of the roll. Thus, the induction heaters at different locations in the direction of the periphery of the roll are positioned at different angles with respect to each other. As can be seen in FIG. 2, the coils are located obliquely with respect to each other in such a manner that the coils in the second row partly fit between the coils in the first row. Furthermore, a main cable 1a to supply electric energy required in the induction heating and to distribute it to different induction coils, and connections 1b, 1c for supplying and discharging cooling medium, e.g. water are also led to the supporting structure 1. According to a known principle, the roll 3 is heated as a result of the eddy currents induced in the roll 3 while the roll rotates and moves past the induction heater.

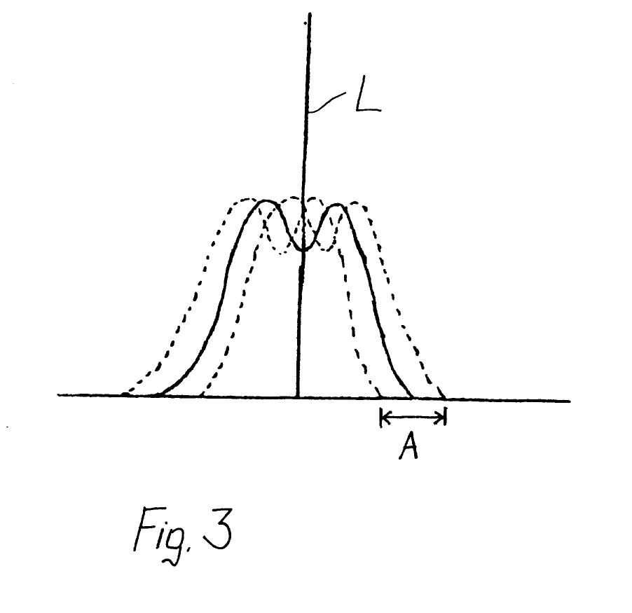

The supporting structure 1 is attached to the frame of the machine by means of slide rails, and connected to an actuator which generates a reciprocating movement in the axial direction of the roll 3, wherein the location of the individual induction coils 2 changes simultaneously in the axial direction of the roll 3 in accordance with the reciprocating movement. This can be utilized to even out the irregularities in the power distribution resulting from the structure of the coil 2, which are illustrated in FIG. 3. FIG. 3 illustrates the heating response as a function of the location in the axial direction of the roll 3 by a single induction coil 2. The unbroken curve describes the effect of the coil 2 in its central position. It can be considered that the vertical line illustrates the location of the central line L (symmetry axis) of the induction coil in the central position of the coil 2, or alternatively fixed points in the roll 3, which are positioned at the same location in the axial direction of the roll 3 and form a line extending around the roll in the peripheral direction. The curve describing the heating efficiency generated by the induction coil 2 in the roll 3 rises towards the middle from the edges, but there is clear minimum point, a “pit” therein between two points of maximum. In the extreme position of the reciprocating movement (broken lines) the area of high heating efficiency (point of maximum) moves to the area of the pit of the central position. With the shape of the curve in FIG. 3, in which the pit is located symmetrically between the peaks that correspond to the points of maximum, the reciprocating movement is implemented with such an amplitude that in the extreme position of the movement, the peaks are positioned symmetrically on both sides of the central line L corresponding to the central position. Thus, the peaks even out the pit on both sides.

The coils move back and forth according to a predetermined pattern. The reciprocating movement has a frequency and amplitude that can be set according to the effect required. However, these variables are not necessarily constant, but they can be changed either during the movement or before the start of a new continuous reciprocating movement of the coils 2.

FIG. 3 also shows that the amplitude of the reciprocating movement does not have to be great, and when the arrangement according to FIG. 1 is used, it is smaller than the width of the zone Z of the induction coil 2. If the aim is to even out the minimum point in the middle of the heating response curve of a single coil in the manner shown in FIG. 3, the amplitude A (the distance between the extreme positions) of the reciprocating movement is approximately one half of the distance between the maximum points on both sides of the minimum point. By selecting the variables of the movement in a suitable manner it is, however, possible also to even out the irregularities resulting from the distance between the induction coils by means of the reciprocating movement. For example the amplitude can be selected such that the minimum and maximum points of the heating response of an unprofiled heating even out as well as possible in the entire axial direction of the roll.

Although the invention is utilized to even out the points of discontinuity occurring in the axial direction in the heating power, the aim of the invention is not necessarily to attain a uniform heating power across the entire width of the roll 3. The invention is advantageously used for profiling induction heating, in which the roll 3 is heated by means of each induction coil 2 with the desired power that differs from the heating power of other induction coils. Thus, the aim of the reciprocating movement is precisely to even out the points of discontinuity in the curve describing the heating power as a function of the position in the axial direction, i.e. to even out such minimum points, which are caused by the structure of the coils 2 and/or mutual spacing of the same, but not such minimum points, which result from a heating power at the location of an induction coil, which has been deliberately adjusted to be below the heating powers of the coils located on its both sides.

Furthermore, according to a preferred embodiment, the heating efficiency of the induction coils 2 is adjusted during the reciprocating movement according to the position by adjusting the current led to the coils 2. Thus, the heating power of the coil 2 changes according to the phase of the movement. This can be conducted very accurately and rapidly, because the power of the induction coils is adjusted electronically. In the adjustment it is also possible to use a sensor, such as an LVDT sensor that detects the position of the induction coils 2 (position of the induction beam). On the basis of the position information given by the sensor, it is possible to change the power automatically according to a fixed formula which determines the power as a function of the position. As a result of the power adjustment depending on the phase of the reciprocating movement it is possible to attain precisely the desired distribution of the heating power. The adjustment is advantageous for example in such a case where it is not possible to even out the points of discontinuity entirely by means of the reciprocating movement, for example the linear speed of the induction coils 2 as a function of the phase of the reciprocating movement is such that the desired result is not attained by means of the movement as such.

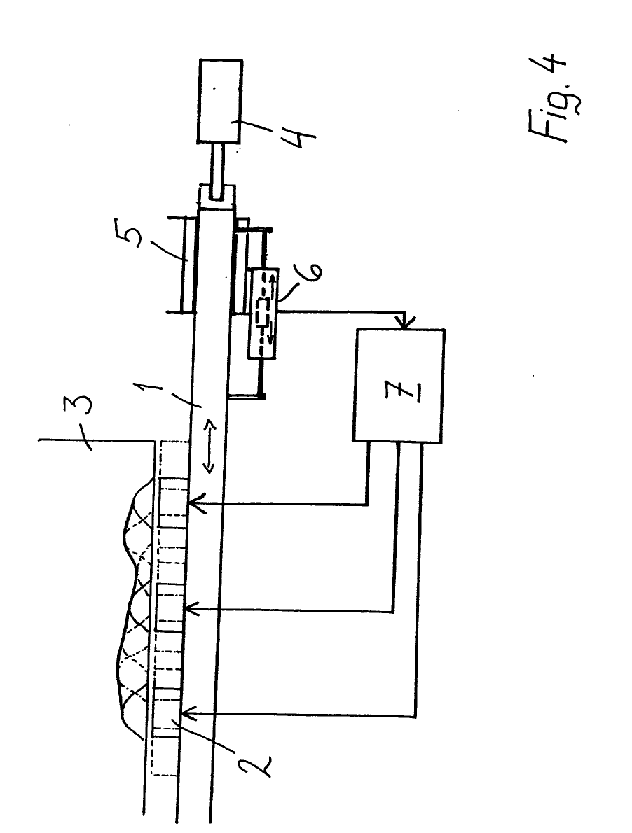

FIG. 4 shows the above-described arrangement and an actuator 4, which is arranged to move the supporting structure 1 back and forth, the end of said supporting structure being arranged to slide on a guide 5. The actuator 4 can be any actuator producing a reciprocating movement, for example a pressurized medium operated cylinder—piston combination moving with a fixed amplitude of motion. The end of the supporting structure 1 is also provided with a movement sensor 6 operating on inductive principle, a so-called LVDT sensor (differential transformer, i.e. Linear Variable Differential Transformer) which detects the position of the structure 1 and the induction coils, respectively, at a given time. The invention is not, however, restricted solely to the use of this type of sensor for detection of position. The sensor 6 is connected to a power control unit 7 that controls the power of each induction coil on the basis of position information by adjusting an electrical variable associated with the function of the induction coil and influencing the heating response, such as the strength of the alternating current supplied to the coil. This power control arrangement can be used in the embodiment of

FIGS. 1 and 2, but FIG. 4 shows such a special case in which the induction coils are spaced by such long distances in the axial direction of the roll 3 that the areas of influence of the same do not overlap. Thus, by means of sufficiently large amplitude of the reciprocating movement it is possible to attain heating also in the areas between the coils, and in a way replace a coil missing in this intermediate area with a coil in the extreme position of the reciprocating movement. Furthermore, by means of the arrangement according to the drawing, it is also possible to implement profiled heating by means of the heating power changing as a function of the position of the coils. Each induction coil 2 is marked with unbroken lines in their central positions and in both extreme positions with a broken line and a dotted line, respectively. The heating responses generated by the coils in the roll 3, which are different depending on the position of the coil, are marked with corresponding lines. The overall profiled heating response generated by the coils in the roll 3 is marked with an unbroken bold line.

Although it is shown in the drawings that the induction heater to be moved back and forth is placed outside the roll, it can also be placed inside the roll to heat the roll shell from inside in a profiled manner.

The roll 3 shown in FIG. 2 can be for example a calender roll which forms a calender nip with a counter element e.g. another roll, through which nip the paper or paperboard web is passed to calender the same. The invention is not, however, restricted to calenders, but it can also be applied for induction heating, advantageously for profiled induction heating of other such rolls which enter in contact with a continuous web travelling in a paper or paperboard machine or finishing machine for paper or paperboard.

We claim:

1. A method for heating a roll (3) in a paper or paperboard machine or finishing machine for paper or paperboard, in which several adjacent induction coils (2) are used which are located at different points in the axial direction of the roll, said method comprising the steps of:
moving the induction coils back and forth in the axial direction of the roll with respect to the roll (3) to be heated.

2. The method according to claim 1, wherein the areas of influence of the induction coils (2) overlap partly in the axial direction of the roll (3).

3. The method according to claim 1 wherein the amplitude of oscillation is smaller than the width of the area of influence of the coil (2).

4. The method according to claim 1, wherein the individual axial power distribution curves of the induction coils (2) contain a minimum point in the central area.

5. The method according to claim 1, wherein the shape of the induction coils (2) is symmetrical with respect to at least one straight line.

6. The method according to claim 1, wherein the power of the induction coils (2) is adjusted during the movement as a function of the position changing as result of the reciprocating movement.

7. The method according to claim 1, wherein the position information depending on the phase of motion of the induction coils (2) is determined by means of a sensor (6) and the obtained position information is used in the adjustment of the power of the induction coils (2).

8. A device for heating a roll in a paper or paperboard machine or finishing machine for paper or paperboard, which comprises induction coils (2) in a supporting structure (1) at different points in the axial direction of the roll (3), wherein the supporting structure (1) is connected to an actuator (4) which brings about a movement of the supporting structure back and forth in the axial direction of the roll (3) to be heated.

9. The device according to claim 8, wherein the areas of influence of the induction coils (2) overlap partly in the axial direction of the roll (3).

10. The device according to claim 9, wherein the induction coils (2) are staggered in two rows in the supporting structure (1).

11. The device according to claim 8, wherein the shape of the induction coils (2) is symmetrical with respect to at least one straight line.

12. The device according to claim 8, wherein the individual axial power distribution curves of the induction coils (2) contain a minimum point in the central area.

13. The device according to claim 8, said device further comprising a sensor (6) which is arranged to determine the position of the induction coils (2) during the movement.

14. The device according to claim 13, wherein the sensor is connected to a control unit (7) which is arranged to change the power of the induction coils (2) as a function of the position of the coils (2) dependent on the phase of the motion.
